(19) United States
(12) Patent Application Publication
(10) Pub. No.: US 2003/0041956 A1
(43) Pub. Date: Mar. 6, 2003

(54) Anti-skid elements for plastic products and products made therefrom

(76) Inventors: Maurice J. Pigott, Winnetka, IL (US); Brandon L. Pigott, Wilmette, IL (US); Schuyler F. Pigott, Arlington Heights, IL (US); Peter S. Pigott, Wilmette, IL (US); Jerry J. Fan, Vernon Hills, IL (US)

Correspondence Address: Roger H. Stein, Wallenstein & Wagner, Ltd., 53rd Floor, 311 South Wacker Drive, Chicago, IL, 60606-6630, US

(21) Appl. No.: 09/943,981

(22) Filed: Aug. 31, 2001

(51) Int. Cl. B29C 47/00; B32B 3/10; B32B 3/20; E04C 2/32; E04C 2/38

(52) U.S. Cl. 156/244.11; 428/134; 428/188; 52/630

(57) ABSTRACT

The present invention relates to hot gas welding of thermoplastic and hot melt spraying, and in particular, to producing anti-skid surfaces on plastic products such as pallets and top frames used for material handling.

### TECHNICAL FIELD

The present invention relates to hot gas welding of thermoplastic elastomers and hot melt spraying, and in particular, to producing anti-skid surfaces on plastic products such as pallets, containers, trays, totes, bins, drums, shelves and top frames used for material handling, and for industry, household, sports and recreation.

### BACKGROUND

It is customary to transport goods and to store goods on pallets. Palletized goods are maintained in a position above the flooring. This is very advantageous in areas where there is flooding or where the condition of the flooring is either rough or of concern. Standard pallets are particularly useful in materials handling because forklift equipment can maneuver the pallets by inserting their forklift tines into channels provided by the pallet. Typically, pallets are constructed of wood. In the past, wooden pallets have provided advantages of economy, simplicity and durability, principally because of the lack of other suitable materials. However, wooden pallets are becoming extremely expensive and problematic for the environment.

In the past decades, plastic pallets have been proposed and, with the growth of the plastics industry, a wide variety of plastics have been investigated to determine their suitability for use in producing pallets. Plastic pallets can be manufactured and are more precise, uniform, cleaner than wooden pallets; also, the plastic used can be composed of recycled materials and can be recycled again. Furthermore, plastic pallets are more durable than wooden pallets.

Recent plastic pallets light in weight, durable, capable of supporting heavy loads, easy to manufacture and have interchangeable parts are disclosed in: PLASTIC PALLET, U.S. Pat. No. 4,843,976, issued Jul. 4, 1989; PLASTIC PALLET, U.S. Pat. No. DES328,175, issued Jul. 21, 1992; PLASTIC PALLET WITH DECK ASSEMBLY, U.S. Pat. No. 5,197,395, issued Mar. 30, 1993; PLASTIC PALLET ASSEMBLY, U.S. Pat. No. 5,343,814, issued Sep. 6, 1994; TWO-PART INTERLOCKING PLASTIC PALLET, U.S. Pat. No. DES346,681, issued May 3, 1994; TWO PART INTERLOCKING PLASTIC PALLET ASSEMBLY, U.S. Pat. No. DES347,511, May 31, 1994; CONNECTOR FOR A PALLET ASSEMBLY, U.S. Pat. No. DES378,458, issued Mar. 11, 1997; CONNECTOR FOR A PALLET ASSEMBLY, U.S. Pat. No. DES354,606, issued Jan. 17, 1995; PLASTIC PALLET ASSEMBLY, U.S. Pat. No. DES364,030, issued Nov. 7, 1995; PLASTIC PALLET ASSEMBLY, U.S. Pat. No. 5,579,686, issued Dec. 3, 1996; CONNECTOR FOR A PALLET ASSEMBLY, U.S. Pat. No. DES378,458, issued Mar. 11 1997; CONNECTOR FOR A PALLET ASSEMBLY, U.S. Pat. No. DES354,606, issued Jan. 17, 1995; PLASTIC PALLET ASSEMBLY, U.S. Pat. No. DES364,030, issued Nov. 7, 1995; PLASTIC PALLET ASSEMBLY, U.S. Pat. No. 5,579,686, issued Dec. 3, 1996; CONNECTOR FOR A PALLET ASSEMBLY, U.S. Pat. No. DES398,731, issued Sep. 22, 1998; CONNECTOR FOR A PALLET ASSEMBLY, U.S. Pat. No. DES412,047, issued Jul. 13, 1999; and, CONNECTOR ATTACHMENT FOR A PALLET ASSEMBLY, U.S. Pat. No. DES398,732, issued Sep. 22, 1998.

The pallets and connectors disclosed in these patents are owned by NUCON CORPORATION of Deerfield, Ill. USA and are highly successful.

While the present pallets support goods and transport goods well, a problem develops if the pallets are tilted, accelerated or decelerated rapidly. In particular, the palletized goods can move or slip while on the pallet. If the tilt, that being the angle between the ground and the pallet, is significant, the goods will slide off the pallet. The same thing can happen when the pallet is accelerated or decelerated during the transporting of the pallet. This is problematic as it can damage the goods or the pallet and can injure individuals in the proximity of the pallet. In addition, slippage can occur between the forklift tines and the pallet (the channels between the pallet base and pallet deck) and between handlers' hands and the pallet. As a result, efforts have been made to minimize the potential for slipping of palletized goods on pallet surfaces and slippage associated with other surfaces of a pallet. These include coating a rough surface on the upper surface, roughing up (e.g., by filing or brushing) the upper pallet surface, placing an anti-slip sheet between the upper pallet surface and the goods to be palletized and adding anti-slip surfaces to the upper surface of the pallet. Often, additional operations and/or devices are required to put on anti-skid or friction devices such as rubber grommets, rubber stripes, rubber grips, friction tapes, etc. in order to prevent products, tools or human hands from slipping. These devices are often put on the plastic pallets by means of mechanical fastening, adhesive bonding, snap or press fit. Unfortunately, these methods and devices have problems associated with them, such as insecure bonding, falling apart, extra parts coming loose, high material costs and high labor costs.

Generally, a goal has been to create a surface having a higher coefficient of friction than the natural surface of the plastic pallet. Regrettably, each of the above solutions has its drawbacks. As to adding an anti-slip surface to the upper pallet, attempts while made, prove to be inefficient, difficult to construct, expensive or short-lived. There is thus truly a need for a product that can overcome these shortcomings.

### SUMMARY OF THE INVENTION

The present invention discloses techniques and methods for creating anti-slip surfaces on the surfaces of plastic products, such as plastic pallets, containers, trays, bins, totes, shelves, decks, drums, etc. The invention further discloses the actual product created by the methods discussed herein. While discussion centers around the upper surface of the pallet, that being the top surface of the deck and the surface abutting and contacting the goods, it is appreciated that the invention can be used on the bottom surface of the base, the surface contacting the support surface such as the ground, and other pallet surfaces where additional friction is desired.

Hot gas welding of thermoplastic elastomers is disclosed, along with hot melt spraying; anti-skid surfaces are produced on plastic products such as pallets, containers, trays, totes, bins, drums, shelves, decks and top frames used for material handling and for industries, household, sports and recreation.

According to a first aspect of the present invention, a base plastic pallet, having a first coefficient of friction, is fused with a second plastic, having a second, higher coefficient of friction to form friction segments on the surface of the pallet. According to a second aspect of the present invention, the second plastic, the one having the higher coefficient of friction, is spayed onto the base plastic pallet to form friction segments on the surface of the pallet. Both techniques produce a pallet surface with increased friction or gripping power than normally associated with the plastic pallet surface. This second plastic is applied by welding or by spraying to the pallet surface in segments and in locations where friction is desired. The plastic segments can be profiled to desired cross sections.

In the first technique and system, an anti-skid surface is applied to the thermoplastic pallet surface (having a first coefficient of friction) by softening the thermoplastic pallet surface by heat, heating a separate thermoplastic elastomer filler to at least a threshold temperature (the thermoplastic elastomer having a second coefficient of friction greater than the first coefficient of friction), fusing the thermoplastic elastomer with the thermoplastic pallet surface, and cooling the fused thermoplastic pallet surface and the thermoplastic elastomer filler. A weld segment is created. The threshold temperature is at least the melting temperature of the thermoplastic elastomer. The filler is either pre-formed stripes or extruded molten beads. The filler can be a thermoplastic elastomer, such as a styrenic elastomer, an olefinic elastomer, a thermoplastic vulcanizate, a thermoplastic polyurethane or a copolyester. The pallet surface can be made of polyethylene, polypropylene, polystyrene, Acrylonitrile-Butadiene-Styrene (ABS), polycarbonate (PC), Polyethylene Terephthalate (PET), Polyphenylene Oxide (PPPO), Polyvinyl Chloride (PVC), or Polymethyl Methacrylate (PMMA).

Either a hot gas welding gun or an extrusion welder is employed to accomplish the above. The filler is a rod made from a thermoplastic elastomer, having a desired profile, or is a pre-extruded thermoplastic elastomer. The filler is fed into a welding tip while the hot gas or air heats the pallet surface and the filler. In the case of the extrusion welding, the welding tip can be a welding shoe having a profiled opening, such as semi-circular, semi-ellipsoid, rectangular, square, triangular or trapezoidal. The welding tip or welding shoe and the filler or the pallet surface can be moved relative to each other during the fusing step to fuse stripes or segments of extrusion onto the pallet surface. The welding tip or welding shoe and the filler can be stationary to the pallet surface during the fusing step to fuse a disc or a pad onto the pallet surface.

A separate heating tool other than a hot air or gas gun can be employed to heat the substrate in the case of extrusion welding. Such tools can include a heated tool (hot plate) and an ultrasonic heating tool.

In a second technique and system, an anti-skid surface is applied to the thermoplastic pallet surface (having a first coefficient of friction) by spraying a hot melt adhesive (the hot melt adhesive having a second coefficient of friction greater than the first coefficient of friction). The hot melt adhesive is first heated to at least a threshold temperature before spraying it onto a pallet or a plastic product, and then cooled. The threshold temperature is the melting temperature of the hot melt. The hot melt adhesive is a thermoplastic, such as a polypropylene, a polyester, a polyamide, an ethylene vinyl acetate copolymer, a styrene-isoprene-styrene copolymer, a styrene-butadiene-styrene copolymer, an ethylene ethyl acrylate copolymer or a polyurethane reactive.

By this technique the hot melt adhesive is heated to its molten state and applied to the pallet surface in the form of droplets, beads or swirled threads. High friction segments are thus created. An applicator is employed to carry and apply the hot melt adhesive to the pallet surface. This applicator is a hand-held heat gun or a system consisting of a heated tank, a pump, a compressed air source, a heated hose, a heated gun with a nozzle. To improve upon the bond between the hot melt adhesive and the plastic pallet surface, the plastic pallet surface can be heated before spraying the hot melt adhesive thereon.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a pallet;

FIG. 2 is a top view of a pallet with high friction segments (and discs) thereon;

FIG. 3 is an illustration of hot gas welding with the hot air/gas tip being separate from the filler rod;

FIG. 4 is an illustration of hot gas string bead welding;

FIG. 5 is an illustration of hot gas extrusion welding;

FIG. 6 shows three profiles of anti-skid segments;

FIG. 7 shows a schematic representation of a pallet without anti-skid devices support supporting goods; and,

FIG. 8 shows a schematic representation of a pallet with anti-skid devices supporting goods.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

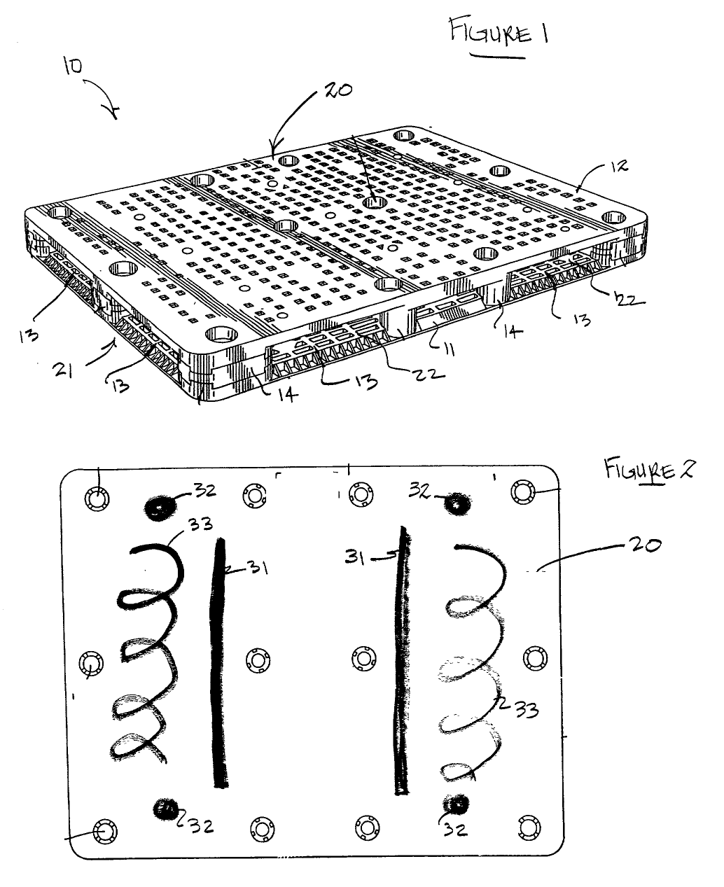

The present invention involves taking a base plastic part, such as a plastic pallet, with a first coefficient of friction and fusing a second plastic having a second, higher coefficient of friction to it. The second plastic is applied to a surface of the base plastic to increase the friction or gripping power normally associated with the base plastic. The second plastic is used in a non-conventional manner and is applied to the base plastic in segments and in locations where friction is desired. For example, a pallet 10 is shown in FIG. 1 having a base 11, a deck 12 and openings 13 for forklift tines (not shown). The base 11 and deck 12 are connected by a plurality of separate or integral connectors 14. Areas of the pallet where additional friction is desired include the upper surface 20 of the pallet 10 to reduce the potential of palletized goods from slipping off the surface, the bottom surface 21 of the pallet to reduce slippage between the pallet and the floor or support surface and possibly the inner surfaces 22 of the pallet contacting the forklift tines to reduce slippage between the pallet and the tines while the pallet is being transported. The plastic segments (e.g., segments or discs 31, 32, 33) can be put in desired locations where additional friction is needed and profiled to a desired cross section. There are primarily two (2) means to apply this second plastic, that being welding and spraying, discussed below.

Hot Gas/Air Plastic Welding

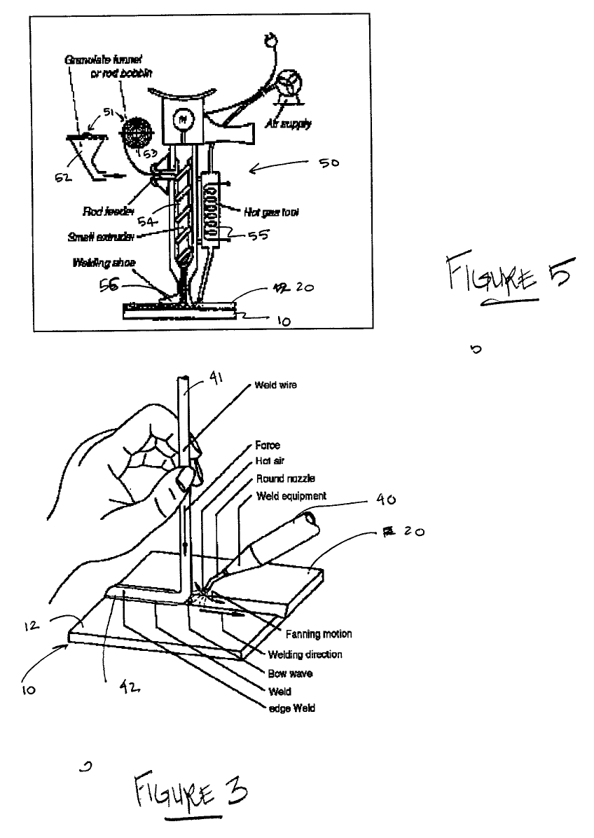

The first technique is hot gas or hot air plastic welding of thermoplastic elastomer material onto the base plastic product. Hot gas welding is used in welding, repairing and sealing applications. See FIGS. 3 and 4 wherein weld equipment 40 is generally shown along with the filler rod 41 and resultant weld (segment) 42. In typical hot gas plastic welding, heated gas or air 40 is used to heat multiple thermoplastic parts 12 and a plastic filler rod 41 to at least the melting temperature. The filler rod and the thermoplastic parts are softened and fused, forming a high strength bond between them (e.g., the filler 41 and pallet 10 to form a weld 42) upon cooling. The filler material is typically identical to the plastic substrates being joined together. On occasion, the filler material is similar to the plastic substrates being joined together. The reason for this is compatibility and welding strength.

The filler rods are typically pre-formed stripes or extruded molten beads. Typical equipment consists of a welding gun, welding tips, a compressed hot gas supply, a welding rod or an extruder.

Elastomers are polymers with rubber-like properties, in particular, the ability to undergo large elastic deformations and recover to their original forms. Elastomers are divided into thermosetting elastomers (TSE) and thermoplastic elastomers (TPE). Thermosetting elastomers are formed and then cross-linked by the application of heat and pressure, a process called vulcanization. Once the polymer is set or cured, further heating generally has little or no effect on the material. The material will, however, be affected if the temperature becomes so high as to oxidize and degrade the part, often forming a char at this point. Examples of thermosetting elastomers are natural rubber, isoprene rubber, styrene-butadiene rubber, neoprene, butyl rubber, ethylene terpolymer rubber and nitrile rubber.

Contrarily, thermoplastic elastomers do not require the vulcanization cycle. Thermoplastic elastomers can be subjected to repeated thermal processing without changing physical or chemical properties very much. They have the advantage of being able to be processed and re-processed on conventional thermoplastic processing equipment. Examples of thermoplastic elastomers are styrenic elastomers, olefinic elastomers, thermoplastic polyurethane and copolyesters.

Elastomers are generally lower in strength and softer than regular plastics. Therefore, they are typically not used to join plastic substrates/materials.

Most of the regular thermoplastics are generally hard and stiff and have low coefficient of friction. They are therefore viewed as slippery in general. Thermoplastic elastomers have a wide range of hardness; their hardness ranges from very soft to being very close to that of regular thermoplastics. They have a relative high coefficient of friction and therefore are ideal for anti-skid purposes.

Contrary to the general purpose of welding (joining many parts/substrates together, repairing plastic parts or sealing plastic parts), the process discussed herein employs thermoplastic elastomers as the filler material 41 and welds the thermoplastic elastomer onto a single base plastic part 12 to act as an anti-skid devices, segments or components 42. One way of doing this is by using a typical hot gas or hot air welding gun for welding. The filler is in the form of a rod or a stripe with desired cross section profile, made of extruded TPE. The rod/stripe is fed into the welding tip while hot gas or hot air is used to heat the base plastic product and the welding rod or stripe. The welding rod/stripe is totally or partially molten and the base plastic (pallet surface) is heated to elevated temperatures and they are fused together.

As shown in FIG. 5, another process for doing this is by using extrusion welding, a variation of hot gas welding. In extrusion welding, the filler 51 is supplied either as pellets delivered through a hopper 52 or as a welding rod from a reel 53. The plastic is then extruded through a screw barrel 54 driven by an electrical motor M. The plastic is molten by electrical heat or mechanical heat, extruded out and is pressed onto the substrate (pallet surface 12) with either a roller or a welding shoe 56. The joint surface is heated by a hot gas (or air) pre-heater 55 attached to the extruder 54. Such extrusion welding was developed to replace multiple pass hand-welds for heavy duty welding applications. This feeding of material in pellets has the further advantage of eliminating the step of making a welding rod or stripe. Thermoplastic elastomers can be supplied in pellet form and be processed through extrusion welding. Extrusion welding with pellets offers higher efficiency and lower cost over regular hot gas welding using preformed rods or stripes.

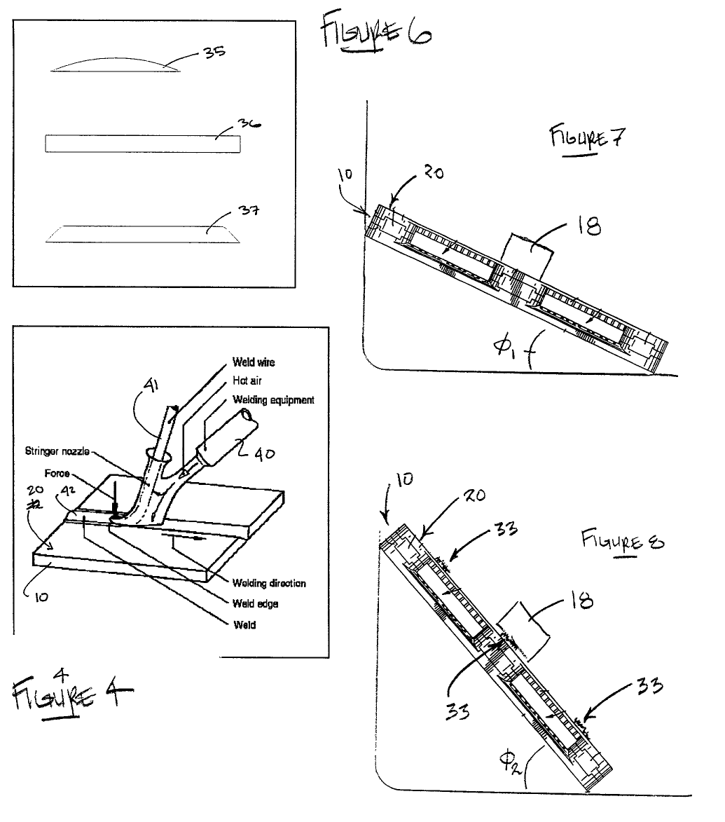

Various shapes of the anti-skid devices can be obtained through the design of the welding rods or the welding stripes. It is more versatile with extrusion welding through the design of welding shoes. The welding shoes can be constructed to have different cross sections. Thus, the desired cross section profile can be easily employed. To form a stripe or segment 31, the welding shoe and the substrate are moved relative to each other in linear or curved direction. To form a disc 32, a circular shape is cut into the welding shoe and the shoe remains stationary. Other shapes could be formed readily as well. Examples of welding stripe cross-sections are shown in FIG. 6. Such cross-sections include semi-circular, semi-ellipsoid 35, rectangular 36, square, trapezoidal 37 or triangular 38.

With both methods, thermoplastic elastomers (TPE) can be welded on to certain plastic such as polyethylene, polypropylene, PVC, PMMA, ABS, PC, PPO, PET, and so on. With proper operation parameters, the bonding has been found to be stronger than the thermoplastic elastomers themselves.

Polyethylene and polypropylene are two of the most popular thermoplastic material. They are also well known for being very difficult to bond together and to other plastic material with conventional adhesive bonding. Thermoplastic elastomers have been found to be capable of being welded to polyethylene and polypropylene and to form a strong bond, offering excellent anti-skid properties. Such thermoplastic elastomers include olefinic based TPE, TPV or TPR and styrenic based TPE, TPV or TPR.

Hot Melt Adhesive Spraying

The second technique and product is spraying hot melt adhesive onto the base plastic product. Hot melt adhesives are solvent-free adhesives characteristically solid at temperatures below the melting point of base thermoplastic, are low viscosity fluids above the melting point, and rapidly set upon cooling. They are generally thermoplastics, such as polypropylene, polyesters, polyamides, ethylene vinyl acetate copolymers, styrene-isoprene-styrene copolymers, styrene-butadiene-styrene copolymers, ethylene ethyl acrylate copolymers and polyurethane reactive.

Hot melt adhesives are used primarily for packaging, textiles, labels, disposable products, stamps and envelopes. They are also used in construction to manufacture laminated wood panels and kitchen counter tops. They are further used in vehicles, aircraft and aerospace industries for structural assemblies and manufacturing. As with welding, hot melt adhesives' primary use is to bond multiple substrates together. They have the advantages of being solvent free, not tacky and not sticking to the products once solidified, and relatively soft when solidified. The adhesives' resistance to humidity and moisture is also relatively good. Their chemical resistances are, however, relatively fair to poor.

Hot melt adhesives also have different performances when bonded to different materials. Polypropylenes based hot melt adhesives offer moderate adhesion to polyolefins and moderate strength, with temperature resistance of around 170° F. Ethylene vinyl acetates have lower tension and peeling strength, with heat resistance in the range of about 120° F. Polyesters provide moderate to high performance in terms of tension and peeling strength with temperature resistance to 200° F. Polyamides offer high performance in terms of tension and peeling strength with temperature resistance of 300° F.

Hot melt adhesives are heated to their molten state and applied to the substrates in the form of droplets, beads and swirled threads (e.g., reference number 33 in FIG. 2), etc. The applicators can be hand-held heat guns or systems consisting of a heated tank, a pump, a compressed air source, a heated hose, a heated gun with a nozzle or similar in nature. Contrary to conventional applications of hot melt as adhesives to bond multiple substrates together, the current invention uses hot melt as the anti-skid devices or segments which are applied onto a single substrate made of thermoplastics. Hot melt adhesives are softer than regular molded thermoplastics. They also have a relatively high coefficient of friction, certainly more than the base substrates of molded thermoplastics and therefore are ideal for anti-skid purposes.

Bonding to the thermoplastic substrates, especially polyolefins, such as polyethylene and polypropylene, can be problematic when used as the hot melt adhesives for anti-skid devices. Tests have been conducted to conventional hot melt equipment employing a hot gas or hot air gun to pre-heat the thermoplastic substrate. This technique improves the bonding between the materials.

By selecting proper hot melt adhesives for a particular substrate made of certain thermoplastic, using proper process equipment, process and operating parameters, proper hardness, bonding strength and application range can be achieved. FIG. 7 shows a plastic pallet 10 without any anti-skid segments thereon. A loaded crate 18 on the top surface 12 of the pallet 10 has a maximum tilting angle φ1 before the crate starts to slide off due to gravity is about 10°. FIG. 8 shows the same plastic pallet 10 with around 10 percent of surface area coated with the hot melt adhesive 33. The maximum tilting angle φ2 is increased to about 45°.

While the specific embodiments have been illustrated and described, numerous modifications can be made without significantly departing from the spirit of the invention, and the scope of protection is only limited by the scope of the accompanying claims.

We claim:

1. A method for providing an anti-skid surface onto a base plastic surface having a first coefficient of friction comprising the steps of:
fusing a second plastic material having a second coefficient of friction to the base thermoplastic material, the second coefficient of friction being greater than the first coefficient of friction.

2. A method for providing an anti-skid surface onto a deck of a plastic pallet's upper surface having a first coefficient of friction comprising the steps of:
fusing a second plastic material having a second coefficient of friction to the base thermoplastic material, the second coefficient of friction being greater than the first coefficient of friction.

3. A method for providing an anti-skid surface onto a thermoplastic base surface having a first coefficient of friction comprising the steps of:
softening the thermoplastic base surface by heat;
heating a separate thermoplastic elastomer to at least a threshold temperature, the thermoplastic elastomer having a second coefficient of friction, the second coefficient of friction being greater than the first coefficient of friction;
fusing the thermoplastic elastomer with the thermoplastic base surface;
cooling the fused thermoplastic base surface and the thermoplastic elastomer.

4. The method of claim 3 wherein the threshold temperature is the melting temperature of the thermoplastic elastomer.

5. The method of claim 3 wherein the elastomer is a filler bar comprising either pre-formed stripes or extruded molten beads.

6. The method of claim 3 wherein the thermoplastic elastomer is a styrenic elastomer, an olefinic elastomer, a thermoplastic vulcanizate, a thermoplastic polyurethane or a copolyester.

7. The method of claim 3 wherein the thermoplastic base surface is a polyethylene, a polypropylene, a polystrayrene, a PVC, a PMMA, an ABS, a PC, a PPO, a PS, or a PET.

8. The method of claim 3 wherein either a hot gas welding gun or an extrusion welder is employed.

9. The method of claim 5 wherein the filler is a rod having a desired profile.

10. The method of claim 9 wherein the filler rod is a pre-extruded thermoplastic elastomer.

11. The method of claim 10 wherein the filler rod is fed into a welding tip while the hot gas or air heats the base surface and the rod.

12. The method of claim 3 wherein the thermoplastic elastomer is extruded during the operation.

13. The method of claim 12 wherein the thermoplastic elastomer is extruded by an extrusion welding gun.

14. The method of claim 12 wherein the thermoplastic elastomer is extruded while the base surface is heated by hot gas.

15. The method of claim 12 wherein the thermoplastic elastomer is extruded while the base surface is heated by a heating tool.

16. The method of claim 11 wherein the welding tip includes a welding shoe having a preselected opening.

17. The method of claim 16 wherein the preselected opening is semi-circular, semi-ellipsoid, rectangular, square, triangular or trapezoidal.

18. The method of claim 9 wherein the filler rod is moved relative to the base surface during the fusing step to fuse stripes on the base surface.

19. The method of claim 9 wherein the filler rod is stationary relative to the base surface during the fusing step to fuse a disc on the base surface.

20. A method for providing an anti-skid surface onto a base plastic surface having a first coefficient of friction comprising the steps of:
spraying a second plastic material having a second coefficient of friction onto the base thermoplastic material, the second coefficient of friction being greater than the first coefficient of friction.

21. A method for providing an anti-skid surface onto a thermoplastic base surface having a first coefficient of friction comprising the steps of:
heating a hot melt adhesive to at least a threshold temperature, the hot melt adhesive having a second coefficient of friction, the second coefficient of friction being greater than the first coefficient of friction;
spraying hot melt adhesive onto the base plastic product, and,
cooling the hot melt adhesive.

22. The method of claim 21 wherein the threshold temperature is the melting temperature of the hot melt adhesive.

23. The method of claim 21 wherein the hot melt adhesive is a thermoplastic.

24. The method of claim 23 wherein the thermoplastic is a polypropylene, a polyester, a polyamide, an ethylene vinyl acetate copolymer, a styrene-isoprene-styrene copolymer, a styrene-butadiene-styrene copolymer, an ethylene ethyl acrylate copolymer or a polyurethane reactive.

25. The method of claim 21 wherein the hot melt adhesive is heated to its molten state and applied to the base surface in the form of droplets, beads or swirled threads.

26. The method of claim 21 wherein an applicator is employed to carry and apply the hot melt adhesive to the base surface.

27. The method of claim 26 wherein the applicator is a hand-held heat guns or systems consisting of a heated tank, a pump, a compressed air or gas source, a heated hose, a heated gun with a nozzle.

28. The method of claim 21 further including the step of heating the plastic base surface before spraying the hot melt adhesive thereon.

29. An anti-skid surface comprising:
a base plastic surface having a first coefficient of friction; and,
a second plastic material having a second coefficient of friction fused to the base thermoplastic material, the second coefficient of friction being greater than the first coefficient of friction.

30. An anti-skid surface comprising:
a thermoplastic base surface having a first coefficient of friction; and,
a separate thermoplastic elastomer having a second coefficient of friction, the second coefficient of friction being greater than the first coefficient of friction, fused to the thermoplastic base surface.

31. The anti-skid surface of claim 30 wherein the elastomer is heated to at least the melting temperature of the elastomer before being fused and cooled after being fused.

32. The anti-skid surface of claim 31 wherein the elastomer is a filler comprising either pre-formed stripes or extruded molten beads.

33. The anti-skid surface of claim 31 wherein the elastomer is thermoplastic elastomer, such as a styrenic elastomer, an olefinic elastomer, a polyurethane or a copolyester.

34. The anti-skid surface of claim 31 wherein the thermoplastic base surface is a polyethylene, a polypropylene, a polystrayrene, a PVC, a PMMA, an ABS, a PC, a PPO, a PS, or a PET.

35. The anti-skid surface of claim 32 wherein the filler is a rod having a desired profile.

36. The anti-skid surface of claim 32 wherein the filler is shaped by a welding shoe having a preselected opening, the preselected opening being semi-circular, semi-ellipsoid, triangular, rectangular, square or trapezoidal.

37. An anti-skid surface comprising:
a thermoplastic base surface having a first coefficient of friction;
a hot melt adhesive having a second coefficient of friction, the second coefficient of friction being greater than the first coefficient of friction applied onto the base plastic product;
a base plastic surface having a first coefficient of friction; and,
a second plastic material comprising a hot melt adhesive having a second coefficient of friction sprayed onto the base thermoplastic material, the second coefficient of friction being greater than the first coefficient of friction.

38. The anti-skid surface of claim 37 wherein the hot melt is heated to at least its melting temperature of the thermoplastic elastomer before being sprayed and cooled after being sprayed.

39. The anti-skid surface of claim 38 wherein the hot melt is thermoplastic based.

40. The anti-skid surface of claim 38 wherein the thermoplastic base for hot melt is a polypropylene, a polyester, a polyamide, an ethylene vinyl acetate copolymer, a styrene-isoprene-styrene copolymer, a styrene-butadiene-styrene copolymer, an ethylene ethyl acrylate copolymer or a polyurethane reactive.

41. The anti-skid surface of claim 37 wherein the hot melt adhesive is heated to its molten state and applied to the base surface in the form of droplets, beads or swirled threads.
